(19) United States
(12) Patent Application Publication
(10) Pub. No.: US 2012/0048235 A1
(43) Pub. Date: Mar. 1, 2012

(54) Leaschauer Engine

(76) Inventor: Eitan Leaschauer, San Jose, CA (US)

(21) Appl. No.: 13/219,384

(22) Filed: Aug. 26, 2011

Related U.S. Application Data
(60) Provisional application No. 61/377,270, filed on Aug. 26, 2010.

(51) Int. Cl. F02M 69/04

(52) U.S. Cl. 123/445

(57) ABSTRACT

Disclosed herein is a novel ICE termed the Leaschauer Engine (LE). The Leaschauer Engine (LE) is a single or multiple step compression cycle ICE machine, employing the Pressure/Heat Detonation Principle (Diesel Principle). The Leaschauer Engine differs significantly from a conventional ICE machine by its ability to employ extreme combustion pressure to achieve high combustion efficiency operation without risking a pre-detonation condition.

### CROSS REFERENCE TO RELATED APPLICATION

This application is related to U.S. Provisional Application No. 6/137,270, filed Aug. 26, 2010, and claims priority thereto.

### FIELD OF THE INVENTION

This invention deals with Internal Combustion Engines (ICE's), and in particular with high combustion efficiency engines.

Definitions: Described hereinafter are definitions of some frequently used terms in the application to assist the reader in understanding the technology.
1. Definition 1: Multi Compression Steps (MCS) ICE Engine: An engine configured to increase the atmospheric pressure by using sequenced multiple compression stages to increase its combustion efficiency (when mixed with atomized fuel at the optimal ratio).
2. Definition 2: Pre (compression) Sequenced Fuel Injection (or Pre SFI): A method to inject fuel into lower than atmospheric pressure air (by injection or other way) prior to the beginning of the compression stage.
3. Definition 3: Post (compression) Sequenced Fuel Injection (or Post SFI): A method to inject atomized fuel foam into compressed air at its peak high pressure and heat stage for high efficiency combustion. In other words to time and manipulate the detonation timing by accurately controlling and timing the fuel injection moment. (This process provides the benefit of enabling extreme high compression combustion without risking pre-detonation).
4. Definition 4: Sequenced Fuel Injector (SFI): A high pressure fuel source that can overcome the peak pressure and heat existing in the cylinder in proximity to the detonation point, and that can deliver the calculated fuel mass required at that moment, by injecting multiple small equal quantities of atomized fuel droplets when detonation heat and pressure conditions in the cylinder are met.
5. Definition 5: Fuel Injector: A fuel valve (which may be electrical or other type such as piezoelectric), capable of delivering a series of small quantity atomized fuel droplets by switching on-off at a rate in the range of micro seconds.
6. Definition 6: Detonation Conditions (of ICE Machine): The conditions (pressure and heat) developed in the cylinder, that cause a specific fuel (defined by its type and octane number) to detonate (when it is in its optimized air to fuel ratio)
7. Definition 7: Leaschauer Engine (LE) machine employing Pre (compression) Sequenced Fuel Injection (Pre SFI) process:
   An engine utilizing two or more sequenced compression steps, implemented as a primary large sized cylinder (“Main Cylinder”), and a secondary, substantially smaller sized cylinder (“Mini Cylinder”) coupled to the main cylinder. Air is vacuumed into the main cylinder prior to the beginning of the compression cycle, and atomized fuel is injected into the main cylinder prior to the beginning of the compression cycle. However, the compression process is sequenced such that in the main cylinder, referred to interchangeably as the low compression stage, pressure and heat will be kept in its pre-detonation condition. Only in the mini-cylinder, referred to interchangeably as the high compression stage, will the pressure and heat achieve detonation conditions. The post detonation gases from the mini-cylinder will then distribute back to the Main Cylinder for the power stroke.
   Note: If for the Pre SFI case, a turbo compressor is added before the main cylinder, the set of the turbo compressor plus the main cylinder is considered as the “low compression stage”.
8. Definition 8: Leaschauer Engine (LE) machine employing Post (compression) Sequenced Fuel Injection (Post SFI) process:
   An engine utilizing a single or multiple step extreme compression process designed such that the detonation is timed and manipulated, by controlling the fuel injection moment to occur post-compression, at substantially the final (highest pressure) point.

### BACKGROUND

The conventional ICE machine has been in use for a very long time. Typical compression ratios in a conventional ICE machine are about 1:10 for a gas engine, and for a diesel engine up to about 1:22.

It is well known in the art that higher combustion pressure yields higher efficiency burning of the gas used. However, there are several reasons why high combustion pressure ICE's are problematic. A first problem inherent in high combustion pressure engines is the necessity for increasing the octane of the gas accordingly, since lower octane gas detonates at a lower pressure and heat, therefore premature detonation would occur in a higher combustion pressure engine unless higher octane gas were used. Chemical limitations to the improvement of gas octane, as well as the high price of high octane products contribute to the limited development of a higher compression gas engine.

A second limitation to the development of higher compression ratio diesel engines is a mechanical limitation. As the compression increases, the mechanical stress on the piston, rod, and crankshaft assembly increases accordingly. For example, a piston having an area of 12 square inches, at pressure of 300 PSI (which is close to the typical pressure resulting from a compression ratio of 20:1, equal to temperature-corrected atmospheric pressure×compression ratio) would yield a force of 3600 pounds on the piston rod. Higher compression ratios would increase the force proportionately. The mechanical stress on the thin piston rod has limited the increase in compression ratios. As existing technologies have entered a “dead end” and are failing to achieve higher combustion pressures, there is a need (which may be one of the world's highest priorities) to step in with a new dramatically, more energy efficient ICE technology, that is pushing the limits of combustion efficiencies to extreme values and therefore increasing combustion efficiency and reducing gas consumption. This would greatly reduce the environmental impact of pollution and global warming.

### SUMMARY

Disclosed herein is a novel ICE termed the Leaschauer Engine (LE). The Leaschauer Engine (LE) is a single or multiple step compression cycle ICE machine, employing the Pressure/Heat Detonation Principle (Diesel Principle). The Leaschauer Engine differs significantly from a conventional ICE machine by its ability to employ extreme combustion pressure to achieve high combustion efficiency operation without risking a pre-detonation condition.

The unique design of the “Leaschauer Engine” allows the use of any fuel (regardless of its octane number) or a mix of fuel products, adjusting itself automatically to temperature and barometric pressure variations.

In its Post (compression) Sequenced Fuel Injection (SFI) version, the inventive technology differs significantly from the conventional technology as follows:
1. The inventive dual compression step structure enables extreme compression ratios, greater than 1:22.
2. Both for the dual compression step structure and for the single compression step structure, the sequencing of injection of atomized fuel/gas foam to inject it at a peak pressure and heat when a desirable detonation point is reached, removes the risk of pre-detonation. As a result, the inventor has recognized that this fuel injection sequencing enables the use of lower octane fuel.

Due to its extreme combustion pressure the Leaschauer Engine is environmentally friendly, i.e. reducing dramatically the exhaust of burning by-products, and the release of residual heat into the atmosphere.

The claimed Leaschauer Engine (LE) technology deals with several solution embodiments to increase the efficiency of Modern Internal Combustion Engine (ICE) machine:
1. A first proposed solution is referred to as a single or multiple stage post (compression) ICE machine. This includes the apparatus and process that support the employment of a Sequenced Fuel Injecting (SFI) process wherein the fuel (gas) is delivered right at the peak compression pressure and heat conditions into the cylinder, to achieve high pressure combustion efficiency. In other words, the fuel (gas) is held out of the cylinder during the sequenced compressing cycle to enable controlling and timing of the detonation occurrence without risking a pre-detonation event. A first embodiment of the post-compression ICE machine employs a larger, lower compression primary cylinder, and a smaller, higher compression mini-cylinder coupled to the primary cylinder.
   A second embodiment of the post-compression ICE machine, termed the Leaschauer Gas Engine (LGE), is a single compression stage high efficiency post SFI engine (See FIG. 8)
2. A second proposed solution is referred to as a Multiple Compression Stage (MCS) ICE machine employing a Pre SFI process, wherein only at the last, high-compression stage (i.e., the mini-cylinder as described above) the detonation conditions of heat and pressure are met.

Practical structural details to enable implementation of either the post-compression SFI or pre-compression SFI methods are described in the Practical Implementation Example for Leaschauer Engine (LE) Dual (or more) Compression Stages. Included in the practical implementation example are: 1. means of enabling the compression ratio to exceed 1:22 without risking pre-detonation; 2. means of enabling the coupling of the low and high compression stages; and 3. a mechanical gearing mechanism to ensure the timing and sequencing of the entire machine.

### BRIEF DESCRIPTION OF THE DRAWINGS

FIG. 1 is a diagram illustrating principles of operation of the dual step high compression cycle.

FIG. 2 illustrates stage 1 of the compression cycle: compression starts building up.

FIG. 3 illustrates stage 2 of the compression cycle: the Mini Piston has passed the cut-off point.

FIG. 4 illustrates stage 3 of the compression cycle: detonation has occurred

FIG. 5 illustrates stage 4 of the compression cycle: Post Detonation and the start of the work cycle.

FIG. 6 illustrates a dual compression step ICE machine employing Post (compression) Sequenced Fuel Injection (Post SFI).

FIG. 7 illustrates the timing gear mechanism.

FIG. 8 illustrates the Leaschauer Gas Engine (LGE) referred to as a single step high (combustion) pressure gas machine employing Post (compression) Sequenced Fuel Injection (Post SFI).

### A General Description of the Dual Step High Compression Operating Cycle.

In an embodiment of the “Leaschauer Engine”, the engine employs a second compressing step that is added to the existing conventional ICE machine.

By dramatically reducing the area of the second stage piston (also referred to as the mini Piston), for example: by a factor of 20, and by leaving intact the conventional pressing mechanism (i.e.: Crankshaft, electrical or hydraulic mechanism), the Mini Piston can achieve extreme combustion pressure (for example: forcing the piston to 1600 pounds using the conventional compressing mechanism, the mini piston could achieve a static combustion pressure of 1600 PSI, assuming the Mini Piston area is 1 square inch).

The second stage piston of the Leaschauer Engine enables the employment of extreme combustion pressure without the need to significantly change the compressing mechanism. The Leaschauer Engine brings the dual stage ICE engine to a new era of extreme efficiency and clean combustion operation.

This novel technology is an integral part of the claimed invention.

### Principle, Brief Description and Method of Operation

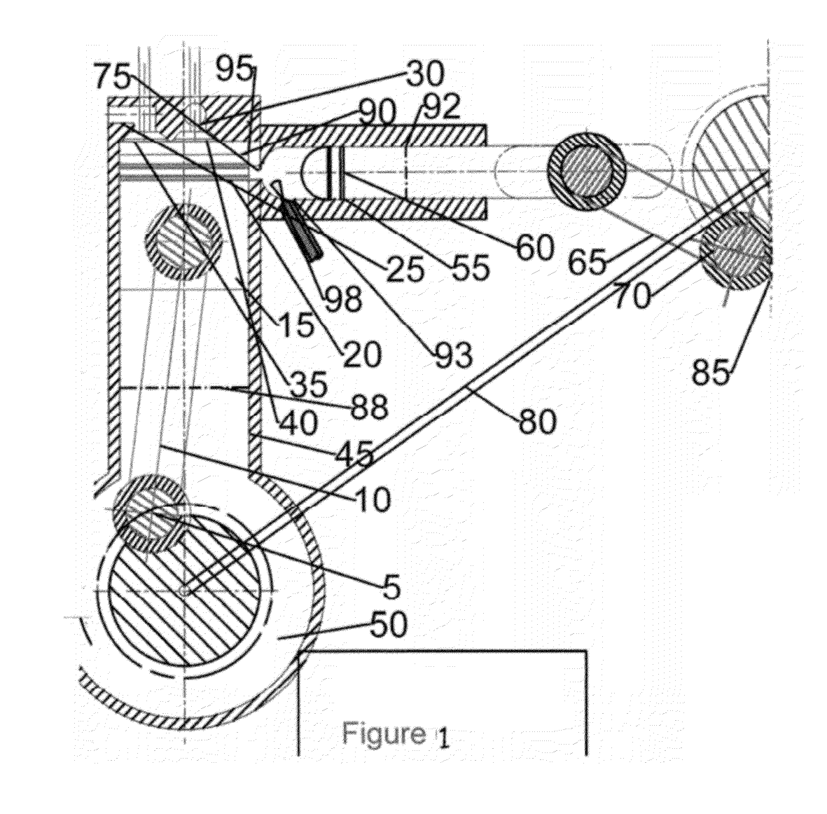

FIG. 1 illustrates the principles of operation of the Leaschauer Engine. The elements shown in FIG. 1 are listed below:

| | | |
|---|---|---|
| 5. Crankshaft Main. | 10. Connection Rod | 15. Piston Main. |
| | Main. | |
| 20. Piston Rings Main | 25. Exhaust Vent | 30. Mixture (or air) Inlet |
| | valve | |
| 35. Exhaust Valve | 40. Mixture (or air) | 45. Main Cylinder |
| | inlet valve | |
| 50. Main Oil Reservoir | 55. Mini Cylinder | 60. Mini Piston |
| 65. Mini Connection | 70. Mini Crankshaft | 75. Cylinders Connection |
| Rod | | Hole |
| 80. Timing Gear | 85. Mini Oil Reservoir | 88. LDP Main |
| Mechanical | | |
| 90. UDP Main | 92. LDP Mini | 93. Mini UPD |
| 95. Main Piston | | 98. Post SFI injector |
| Leading edge | | system |

To better understand the operating principles of the new Leaschauer Engine, its unique structure, its method of operation and functionality, it is important to start with the description of the Compression Cycle, which is unique to the Leaschauer Engine

A. The compression cycle,

Preconditions Snapshot

Prior to the start of the compression cycle, the Main Piston 15 traveled from Main UDP 90 down toward Main LDP 88 while (for the pre SFI) the inlet/mixture/Air valve 40 is open to input or vacuum mixture (air/fuel for the pre-compression SFI version, or only air in the Post compression SFI version) into the cylinder space. The Mini Piston 60 is maintained at Mini LDP 92.

1. When the Main Piston 15 reaches LDP 88 the preconditions are as follows:
Main Cylinder 45 contains:
a. Fresh air (in close to atmospheric pressure or higher if turbo is installed) for the Post SFI version;
b. A mixture of air and atomized fuel foams in the Pre SFI version.
c. The inlet valve 30 and the exhaust valve 35 are in their closed states.

The Compression Stage Begun:

The Main Piston 15 (when all preconditions are met) travels from its Main Lower Dead Point (“LDP”) 88 up the Cylinder 45 towards the Main Upper Dead Point (“Main UDP”) 90. The mixture (or air) is being compressed. While the main piston travels up towards the Main UDP some of the compressed mixture (or air) passes through the passage 75 to the Mini-Cylinder 55 to maintain pressure equilibrium. (At that stage the Mini Piston 60 is kept at the Mini Lower Dead Point, (“Mini-LDP”), 92.

B. Main piston leading edge has passed the cut off point

When the Main Piston reaches UDP 90, the mixture (or air) is fully contained in the Mini Cylinder 55. At that point the Main Piston Leading Edge 95 has already passed the narrow passage “75” (the cut-off point) and the mixture (or air) is fully contained and locked in the Mini Cylinder 55.

Note: Throughout the article the term “air” indicates the Post SFI version, the term “mixture” indicates the Pre SFI version.
C. Mini Cylinder is further compressing the mixture (or air)

The Gearing Mechanism 80 is engaged and forces the Mini Piston to travel towards the blocked passage 75 (Mini UDP) to further compress the mixture (or air) and bring it to extreme pressure and heat.

### D. Detonation

D.1 For the Pre-(compression) SFI case, the extreme pressure and heat developed during the compression cycle in the Mini Cylinder 55 detonates the mixture at a point located along the Mini Piston's journey upward (towards Mini UDP 75). At that point in the cycle for the Post (Compression) Sequenced Fuel Injection (Post SFI) version the Sequenced Fuel Injector (SFI) 98 injects atomized fuel into the compressed air at its peak high heat and pressure and causes the atomized fuel to detonate.
D.2 The detonation Point is dependent on the fuel's octane, and on the combustion pressure and heat.
D.3 The detonation point along the Mini Cylinder 55 (for the pre SFI version) does not affect the timing of the Work Cycle in the Main Cylinder at all; its timing only depends on the Leading Edge 95 which determines the cut-off point of the Main Piston (or a valve, if one is chosen to be used).
D.4 When its start its journey down, the Main Piston 15 exposes opening 75 by the leading edge 95 and opens the way for the post burned gases to break through the opening 75 and force the main piston 15 down to start the work cycle journey.
D.5 Without losing the generality of the principle description above the process above is an integral part of the claimed invention.

### E. The Non Dependency Effect (NDE) of the Leaschauer Engine

E.1 As evidenced from sections D.2-D.4 there is no direct correlation between the detonation timing event (in the Mini Cylinder 55) and the leading edge 95 timing event (i.e., exposing the passage 75 by the leading edge of the main piston 15). Therefore there is no dependency between the Work Cycle and the Detonation Point.
E.2 As a result, the Leaschauer Engine's performance is unaffected by changes in barometric pressure or temperature or by the fuel's octane in use, (unlike conventional ICE engines).
E.3 Accordingly, the design of the Leaschauer Engine ensures that the main work cycle follows the detonation event depending only on the location of the leading Edge 95 in reference to the passage 75 (the exposing point/cutoff point). This fact reduces dramatically any dependency on the fuel in use.

### F. The Work Cycle

F.1 Position of pistons:
F.1A Mini Piston
   At the beginning of the work cycle the Mini Piston is positioned just before Mini UDP 93, which at that stage is already under a heavy load of post detonation gases, (at a high energy potential) ready to assist in the work cycle. At that stage the Load, Gearing Mechanism and the Connecting Rod are holding the Mini Piston from rolling down.
F.1B Main Piston
   At the beginning of the work cycle the Main Piston is positioned at Main UDP 90, at a point located just where the leading edge 95 is about to expose the connecting hole 75.
F.2 When main piston 15 moves down from Main UDP 90 and passage 75 is exposed, post detonation burned gases can break through the passage to the Main Cylinder to load the Main Piston with High energy Post-Detonation Gases.
F.3 At that point of the cycle both pistons are under a heavy load of post-detonation gases, and are geared to carry the load together (as teamwork and to continue the Work Cycle.
F.4 The Work Cycle lasts as long as the high energy maintains the load on the pistons downward.

### G. The Exhaust Cycle

At the end of the work cycle when the main piston 15 starts its journey up, the exhaust valve 35 opens to let the burned products exhaust.

### H. The Mixture/Air Loading Cycle

When piston 15 travels down again, the Exhaust Valve 35 closes and the mixture (or air) valve 40 opens to let the mixture (or air) be vacuumed into the cylinders.
   I. Cycle starts all over again
All valves close to start the compression cycle all over again.

### The Leaschauer Engine Post Compression Fuel Injector Version

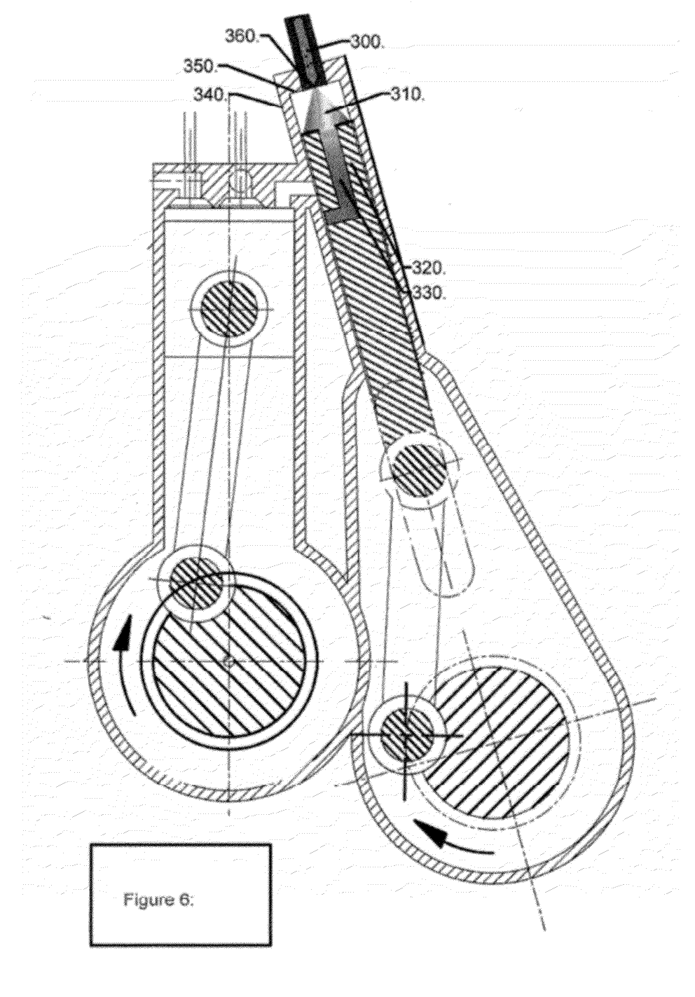

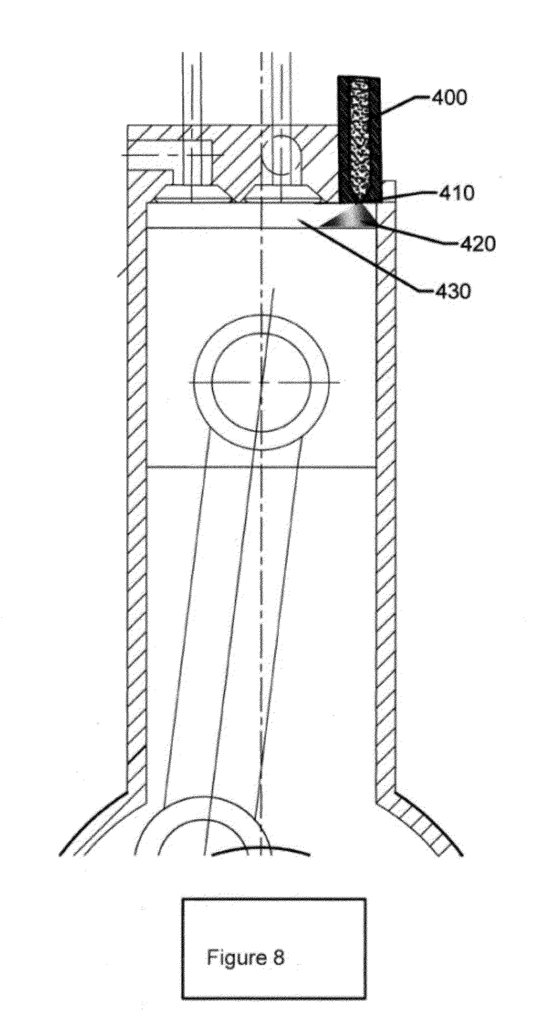

An embodiment of the Leaschauer engine, termed the Post (compression) Sequenced Fuel Injector (Post SFI) version, is described below. The Post SFI version contains but is not limited to a practical detailed implementation of the LE and it is an integral part of the invention. This embodiment is illustrated in FIG. 6. As it already defined on P.5, L.6 and on P.12, L7 and P.11, L28 this category includes the Leaschauer Gas Engine (LGE) which is a single (see FIG. 8), or multi (see FIG. 6) stage(s) high efficiency gas engine. The elements shown in FIG. 6 are listed below:
300. Sequenced high pressure fuel line.
310. Atomized fuel fumes sequenced to be injected into the mini cylinder at the end of the compression cycle when the mini piston is about to reach UDP 350 and when pressure and heat is sufficient to detonate the injected foam.
320. Mini Piston
330. Center Hole.
340. Mini Cylinder
350. Mini UDP
360. Injector
In this Post (compression) SFI embodiment the atomized fuel fumes are sequenced to be injected to the mini cylinder at the end of the compression cycle (when the final stage piston is about to reach UDP). At that point the pressure and heat at their peak values, and is the optimal time to inject fuel foam into the cylinder to cause the atomized fuel foam to detonate and to perfect the Leaschauer Engine performance.
The claimed embodiment and process defined by Post (compression) Sequenced Fuel Injection (Post SFI) and the term Leaschauer Gas Engine (LGE) are integral parts of the claim herein.

### The Leaschauer Single Step Gas Engine (LGE) Machine (See FIG. 8)

FIG. 8 illustrates the practical embodiment and process of a single compression stage LGE Machine. The elements shown and numbered on the figure are listed below:
405. High pressure Post (compression) Sequenced Fuel line.
410. High pressure Post (compression) Sequenced Fuel Injector (SFI).
420. Atomized Sequenced Fuel Foams
430. High pressure and heat Post compression air at the optimum air fuel ratio receiving the droplets of fuel which in this condition will cause detonation to occur.
The benefit gained by using Post (compression) Sequenced Fuel Injecting (SFI) as claimed above can be used also in one compression step to implement low octane high efficiency Leaschauer Gas Engine (LGE) (ex. to use high “single” compression step like diesel engine employing Post SFI process and to inject low octane sequenced fuel foam after the compressing buildup is already in its full swing. Holding out the gas until detonation conditions are met avoids the risk of pre-detonation condition. This process can enable the use of high efficiency “Leaschauer Gas Engine” (LGE) to use a low octane gas as a fuel on Diesel principle.

Practical Engine Embodiment of the “Leaschauer Engine”

FIG.'S 2-7 illustrate an embodiment of an implementation of the Leaschauer Engine. This implementation is referred to as the “practical engine implementation”. This example differs slightly from the embodiment illustrated in FIG. 1, in that for the practical implementation embodiment, the Mini Piston controls the passage 175 for post detonation gases, whereas in the embodiment of FIG. 1, the main piston controls the passage 75. This example clearly indicates that there are many implementation variations of the claimed apparatus and method. Despite the differences, the Non Dependency Effect (NDE) does not change.

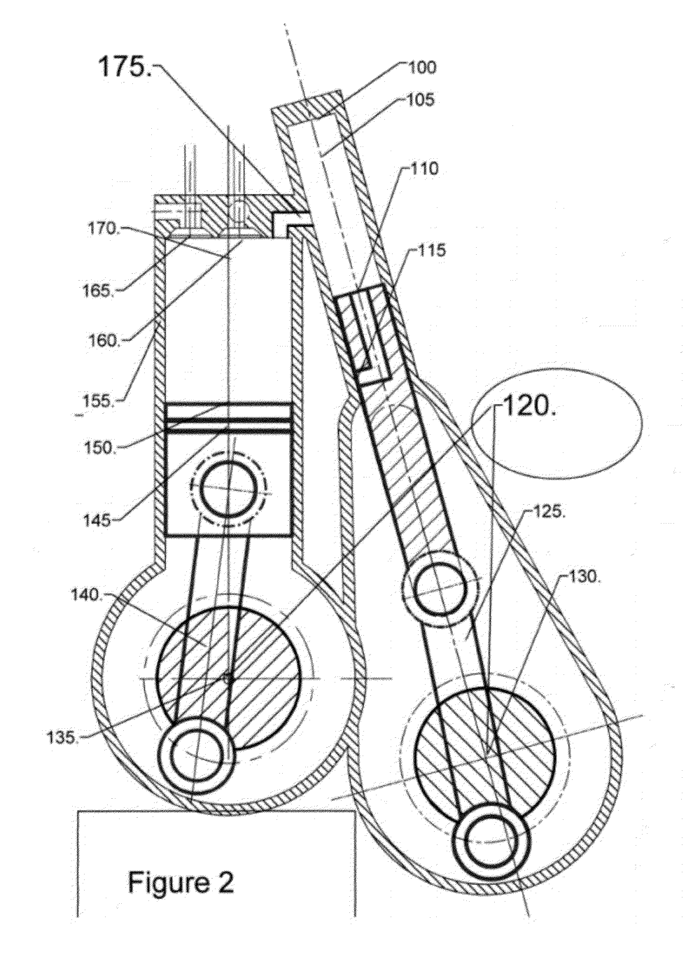

FIG. 2 illustrates an overview of the practical embodiment of the LE. Further details are disclosed in subsequent figures about elements such as the gearing elements. The elements shown and numbered on FIG. 2 are listed below:

| | | |
|---|---|---|
| 100. Mini UPD. | 105. Mini Cylinder. | 110. Mini Piston |
| | | at lower dead |
| | | point. |
| 115. Center Hole Blocked | | |
| in Low end by the cylinder | | |
| walls at piston's current | | |
| position. | | |
| 120. Gearing Mechanism | 125. Mini Pushing rode. | 130. Mini |
| | | crankshaft. |
| 135. Main Crankshaft | 140. Main Pushing rode | |
| 145. Main Piston at | 150. Lower Dead Point | |
| lower dead point | or LPD | |
| 155. Main Cylinder. | 160. Mixture Valve | 165. Exhaust |
| | | valve |
| 170. main UDP | 175. Connection Hole | |
| | maintains pressure | |
| | equilibrium on both | |
| | cylinders at the | |
| | first compressing stage. | |

The LE ICE machine differs from a conventional ICE one in that the Leaschauer Engine has a connection hole/passage 175 on its top Main UDP 170 to allow the gases in the compressed cycle to be delivered to the Mini Cylinder 105.

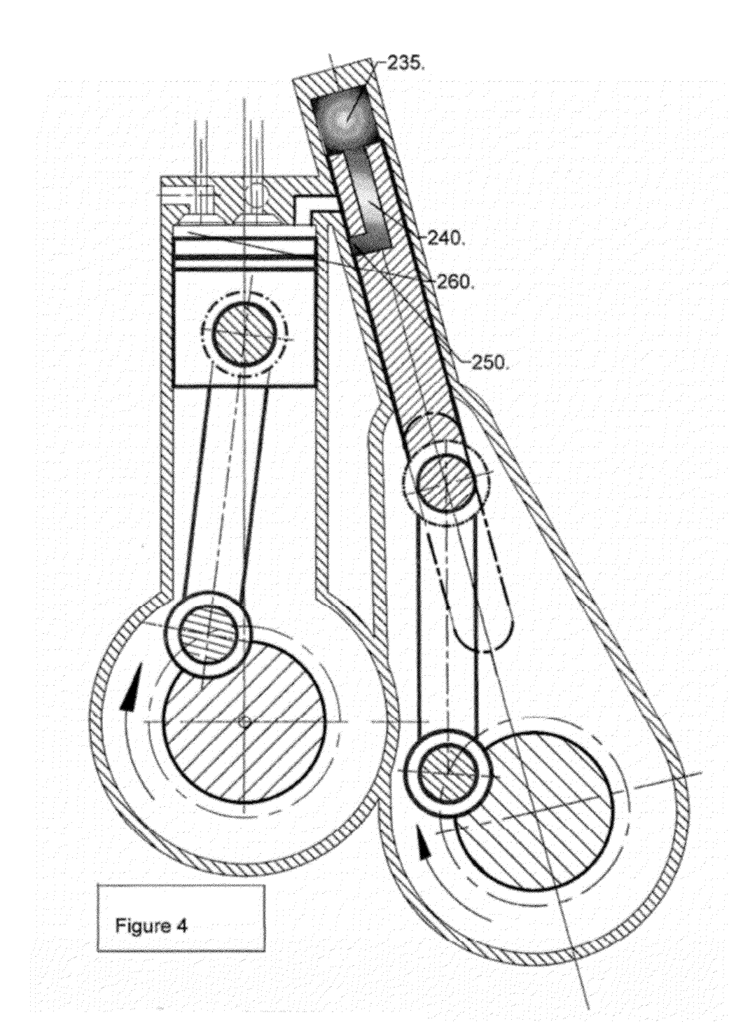

The connection hole/passage 175 is located along the Mini Cylinder 105 on its up journey, just before its detonation point see FIG. 4 (generally at the statistical point where the lowest octane fuel is intended to be used; it is detonated under the heat and pressure of the compression cycle). Still, a safe distance should be kept from the detonation point, to avoid unexpected detonation as well as to gain stability of operation.

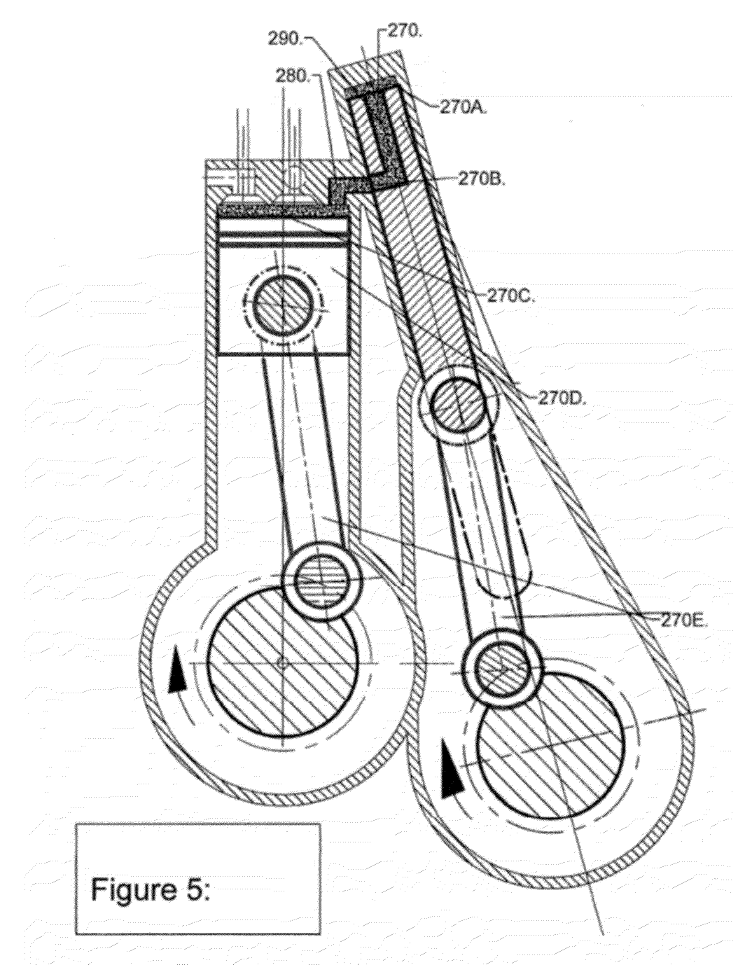

Passage 175 or 270B is also used at the work cycle to redirect the high energy gases so as to return to the main cylinder at the start of the work cycle, as shown in FIG. 5.

Another difference between the Leaschauer Engine ICE machine and a conventional ICE is the timing mechanism gearing which transfers the rotation movement from the main crankshaft 135 to the secondary crankshaft 130 in sequence to ensure its timing, functionality, stability, cleanliness and efficiency of operation

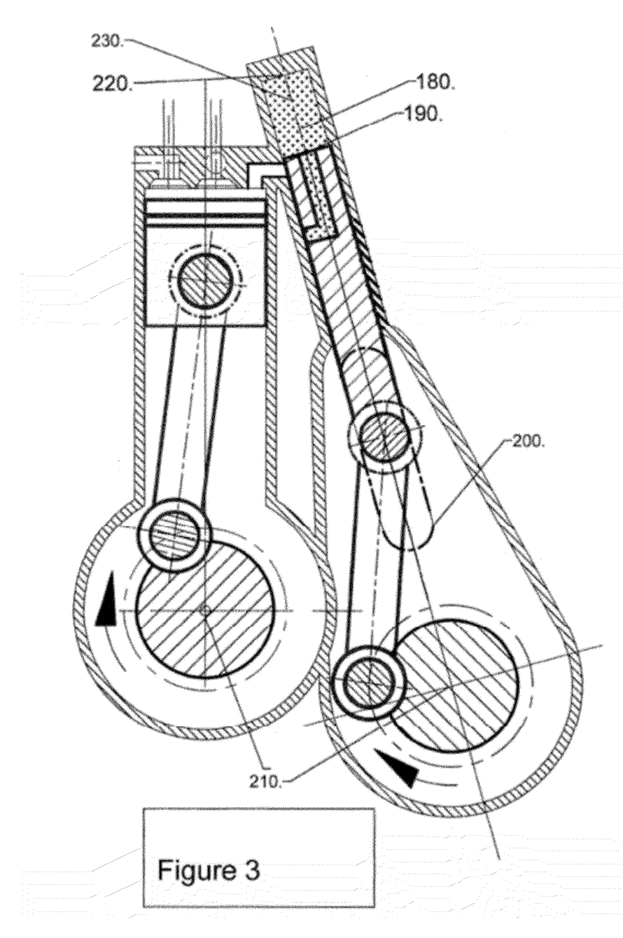

FIG.'S 2, 3, 4, and 5 illustrate details of the practical embodiment and its operation. The elements shown and numbered on FIG.'S 3-5 are listed below: FIG. 3:

| | | |
|---|---|---|
| 180. mixture | 190. Cut-off Point | 200. Mini Piston Guiding |
| | | Rail |
| 210. Gearing System for | | |
| engaging and timing | | |
| the mechanical | | |
| movement between the | | |
| crankshafts. | | |
| 220. Mini UDP | | |
| 230. At this stage the mini | | |
| piston passes the cut-off | | |
| point_and the mixture is | | |
| fully contained and locked | | |
| in the mini cylinder. The | | |
| mini piston is pushed to | | |
| UDP 220 by the gearing | | |
| mechanism to complete | | |
| the compression cycle | | |
| where the heat and pressure | | |
| will detonate the mixture | | |

### FIG. 4:

| | |
|---|---|
| 235. The extreme heat and | |
| pressure detonate the mixture in the | |
| mini cylinder and in the center | |
| hole, which is also used as a gas | |
| expansion space. | |
| 240. Center Hole | 250. The center hole is blocked by |
| | the cylinder walls at the current |
| | position. |

### FIG. 5:

270. At the post detonation stage the mini piston has reached UDP and the following has occurred:
270A. mini piston is loaded with post detonation gases at extreme pressure and energy
270B. the mini piston center hole” is aligned with the connecting hole to open a passage” for post detonation Gases to reach the main cylinder.
270C. As a result post detonation gases are applying extreme pressure on the main piston as well.
270D. The main piston along with the mini piston, under the load of post detonation gases, together convert the load to be applied to the rotational work cycle.
270E. Pushing rods set in position to transfer the work load to the crankshaft
280. Connecting hole.
290. Center hole.

### Details of the LE Practical Embodiment Compression Mechanism

The mini cylinder 105 is added to the Leaschauer Engine to further compress the mixture to an extreme pressure in order to achieve high performance high efficiency and clean detonation.

The gearing mechanism 120 slows down/delays the rotation movement of the main piston 260 and keeps it in proximity of Main UDP 220 while pushing/advancing the mini piston 230 towards the detonation point (the detonation point refers to the final stage piston statistical location point where the lowest octane fuel at the increasing compression process will detonate. (See illustration 4 for a general idea of the piston position). Note: As mentioned earlier, the connection passage 175 is positioned just before the detonation point along the mini cylinder, but at a safe distance from it to avoid risking unexpected detonation and to gain stability of operation.

At Mini UDP 100 the mini piston's center hole 270A, 270B is aligned with the connecting hole, a position which enables the return of gases via the passage, to release the post detonation gases (at extreme energy and high pressure conditions) to the main cylinder 270D to start the work cycle.

This event occurs, as mentioned and as illustrated in FIG. 5, when the mini Piston 270A reaches the Upper Dead Point 270 and exposes the return hole/passage 270B-280.

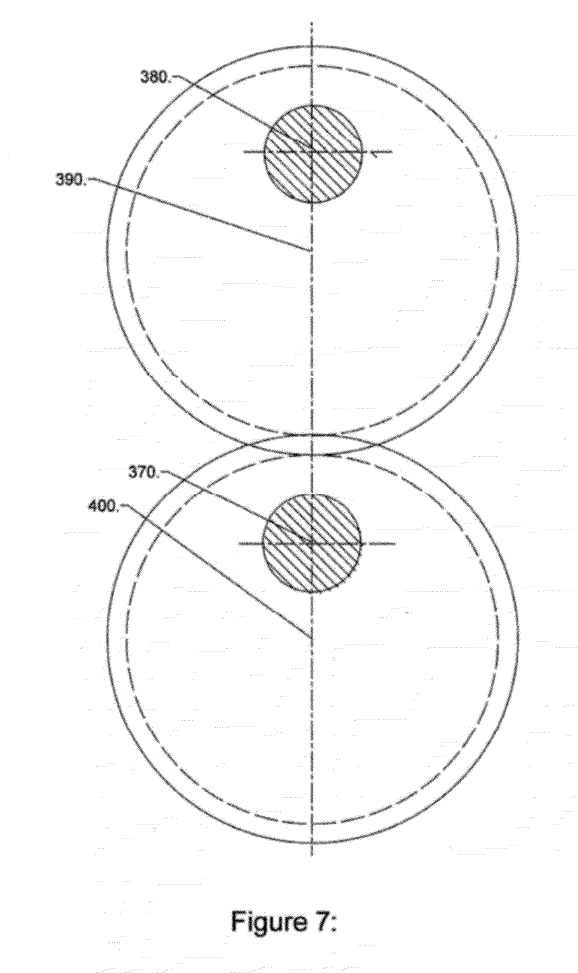

FIG. 7 illustrates in more detail the timing gear mechanism 120, which is an integral part of the claimed invention. The elements shown in FIG. 7 are listed below:

370. Main Crankshaft

380. Mini Crankshaft

390. Mini non-eccentric elliptical teeth wheel

400. Main non-eccentric elliptical teeth wheel

Timing gear mechanism 120 is comprised of (See FIG. 7) two elliptical non-eccentric teeth-wheels. The driver wheel 400 is connected to the main crankshaft 370 and the driven wheel 390 is connected to the secondary crankshaft 380.

The teeth-wheels' respective speeds depend on the momentary ratio between their radii that are designed to suit the angular speed required for efficient operation of the crankshafts 380, 400 and the entire engine.

### Details of the Leaschauer Engine Operating Cycle as Illustrated by the Practical Embodiment:

### Compression Cycle

The Compression Cycle, illustrated in FIG.'S 2-5, begins when all valves 160-165 are closed and the main piston 145 is forced up from its LDP by the gearing mechanism at a fast pace to travel from the lower dead point 150 towards the upper dead point 170. The mini piston is maintained at the mini LDP 110.

Step 1: In the 1^{st} step of the compression cycle, (see illustration 2) a portion of the compressed mixture (or air) from the main cylinder 145 passes to the mini cylinder 105 via the connecting hole 175 to maintain equilibrium pressure between the cylinders.

Step 2: During the 2^{nd} step of the compression cycle (see illustrations 2, 3) the timing gearing mechanism ensures that as the main piston reaches its Upper Dead Point 170 the mini piston 105 reaches its cut-off point 190, (the point where the mini piston passes the connecting hole 175 and gases are fully contained and locked in the mini cylinder 105 as well as in the Center Hole 115).

Step 3: During the 3^{rd} Compression step, the gearing mechanism ensures that the main piston is still maintained in proximity of the Upper Dead Point 170 and that the mini piston 190 is pushed out towards the detonation point.

Step 4: During the 4^{th} step of the Compression cycle (see illustration 4), the pressure and temperature are dramatically increasing, causing the mixture (for the pre SFI version) to detonate. Alternatively, for the post SFI version, at peak pressure and heat, fuel foam is injected and detonated.

After detonation has occurred, the mini piston continues to be advanced upwards by the gearing mechanism, and the pressure and heat keep increasing. This ensures that all fuel products with higher octane numbers have sufficient conditions to burn as well as the time which such burn requires. (see note 4 P.19, L.5 for the Sufficient Combustion Process or (SCP)

When the mini piston is further advancing (See Illustration 5) towards the Mini Upper Dead Point 270A, the mini piston central hole 290 is aligned with the connection hole 280. At that position the passage 280, 290 open and enables the streaming of post detonation gases to be released to the main cylinder. At that point the work cycle begins.

Note: since the location of the connecting hole 280 along the mini cylinder determines the cut-off point in the mini cylinder, it is crucial to correctly position the cut-off point as close as possible to the detonation point. The positioning of the cut-off point should be based on the lowest octane fuel intended to be used.

The design, the process and the engine implementation structure included herein are an integral part of the claimed invention.

### Work Cycle

The work cycle is illustrated in FIG. 5.

The Mini Cylinder Action:

At the compressing stage and especially after the detonation, high pressure, high energy post detonation gases apply a tremendous pressure on the mini piston 270A. Due to the small area of the mini piston, the mini piston rod is able to mechanically withstand the high pressure. The gearing mechanism ensures that the mini piston travels all the way to Mini UDP against the heavy load to complete the compressing cycle.

The Main Cylinder Action:

The gearing mechanism keeps the main cylinder in proximity of the Main UDP 270D until the mini piston reaches its UDP 270 (the point where the center hole 290 is aligned with the connecting hole 280 and the passage 280, 290 lets post detonation gases break through and reach the main cylinder).

### The Pistons Work Together to Carry on the Work Cycle.

After the post Detonation gases have loaded the main piston, the main piston works as a team with the mini piston in carrying on together the work load.

The work cycle lasts as long as the high energy and high pressure of the post-detonation gases are maintained, to force the main and mini pistons down to their respective LDP's.

### Exhaust Cycle

The exhaust cycle elements are illustrated in FIG. 2.

When the main piston 145 reaches the Lower Dead Point LDP 150 and starts its journey up, the exhaust valve 165 opens and enables the burned gases to be released and exhausted.

### Mixture (or Air) Load Cycle

The Mixture (air) load cycle elements are illustrated in FIG. 2.

When the main piston reaches the Upper Dead Point 170 and starts its journey down, the exhaust valve 165 closes, and the mixture (or air) valve 160 opens, thus letting fresh mixture (or air) to be vacuumed into the main cylinder.

As the main piston reaches the Lower Dead Point again both valves are kept closed and the compressing cycle starts again.

### Notes

Note 1: It is important to mention that during the times the cleaning cycle and the mixture (or air) loading cycle are being performed in the main cylinder; the mini piston is repositioned in an idle mode, unless geared to 0.5 of the main piston speed.

Note 2: It is also important to mention that a different embodiment of the Leaschauer Engine (See illustration 6 and P.4, L27) could significantly improve the atomized fuel loading cycle by timing the fuel 300 to be injected directly to the mini cylinder 340 (at a post compression sequenced positive high pressure), a process that could improve the timing and combustion efficiency. This improvement is an integral part of the claimed invention.

Note 3: In order to reduce the dimension size of the Leaschauer Engine a mini piston guided rail 200 is added. The guide is necessary to enable the use of a shorter mini piston, preventing long term damage to the mini piston due to the cross (side) pressure component forced by the mini connecting rod on the piston. The guide supports the mini piston in its LDP stage 110 from shifting sideways due to the pushing rod action. The mini piston guide rail is an integral part of this invention.

Note 4: It is further important to note that in the EL design stage the total length of the mini cylinder has to take into consideration the combustion period of the fuel products. That period continues beyond the detonation point and while the fuel product is still in the burning stage the mini piston is further compressing the burning mixture, all the way up until reaching UDP, to ensure completion of the combustion process. The claimed note 4 termed Sufficient Combustion Process or (SCP) is integral part of the invention

The result of the Leaschauer Engine SCP process is to ensure that the fuel is detonating and that all the fuel components have completed their burning process before mini piston 320 reaches UDP 350.

The Leaschauer Engine benefits from the aforementioned qualities by handling very well multi (mixed) octane fuels, as the detonation pressure and heat are increasing dramatically as the fuel continues to burn within the final compressing (mini-) cylinder until the mini-cylinder reaches the Mini UDP.

The SCP process and the notes above are an integral part of the claimed invention.

It is not expected that the invention be limited to the exact embodiments disclosed herein. Those skilled in the art will recognize that changes and modifications may be made without departing from the inventive concept. The scope of the invention should be construed in view of the claims.

With this in mind, I claim:

1. An apparatus comprising:
an internal combustion engine designed to provide a compression process, said internal combustion engine including:
a main piston housed in a main cylinder; and
a secondary small-dimension piston housed in a small dimension cylinder, said secondary small-dimension piston and cylinder configured to achieve a high compression ratio during said compression process to yield extreme fuel combustion pressure;
said secondary small-dimension cylinder coupled to said main cylinder in a configuration to enable transference of said extreme fuel combustion pressure from said secondary small-dimension cylinder to said main cylinder to enhance operation of said main piston.

2. The apparatus of claim 1, wherein said high compression ratio is greater than 22:1.

3. The apparatus of claim 2, configured to enable a mixture of fuel and air to fill said main cylinder prior to compression of said main cylinder, and configured to maintain said main cylinder in pre-detonation pressure and heat conditions during said compression process.

4. The apparatus of claim 3, further configured to enable a mixture of fuel and air to fill said small dimension cylinder prior to compression of said small dimension cylinder, and configured to reach detonation pressure and heat conditions during said compression process, thereby releasing post-detonation gases into said small dimension cylinder to yield extreme fuel combustion pressure.

5. The apparatus of claim 4, further configured to enable distribution of said post-detonation gases into said main cylinder to aid in a main cylinder power stroke.

6. The apparatus of claim 2, configured to enable air to fill said main cylinder and said small dimension cylinder prior to compression of said small dimension cylinder, and further configured to enable injecting of atomized fuel into said small dimension cylinder at a point in said compression process where pressure and heat are at peak values and cause said atomized fuel to detonate and yield post-detonation gases.

7. The apparatus of claim 6, further configured to enable distribution of said post-detonation gases into said main cylinder to aid in a main cylinder power stroke.

8. An apparatus comprising:
an internal combustion engine designed to provide a compression process, said internal combustion engine including:
a main piston housed in a main cylinder;
said apparatus configured to enable air to fill said main cylinder prior to compression of said main cylinder, and further configured to enable injecting of atomized fuel into said main cylinder at a point in said compression process where pressure and heat are at peak values and cause said atomized fuel to detonate;
wherein said engine is enabled to utilize low-octane fuel without pre-detonation.

9. A compression process for an internal combustion engine having a main cylinder and a secondary small dimension cylinder coupled to said main cylinder comprising the steps of:
filling said main cylinder and said small dimension cylinder with air;
injecting atomized fuel into said small dimension cylinder at a point in said compression process where pressure and heat are at peak values and cause said atomized fuel to detonate and yield post-detonation gases;
releasing said post-detonation gases into said small dimension cylinder to yield extreme fuel combustion pressure; and
distributing said post-detonation gases into said main cylinder to aid in a main cylinder power stroke.
